(19) United States
(12) Patent Application Publication
(10) Pub. No.: US 2024/0318768 A1
(43) Pub. Date: Sep. 26, 2024

(54) ROTATION MECHANISM WITH SLIDING JOINT

(71) Applicant: Corephotonics Ltd., Tel Aviv (IL)

(72) Inventors: Gil Bachar, Tel Aviv (IL); Ephraim Goldenberg, Tel Aviv (IL); Noy Cohen, Tel Aviv (IL); Yiftah Kowal, Tel Aviv (IL)

(21) Appl. No.: 18/675,309

(22) Filed: May 28, 2024

Related U.S. Application Data
(63) Continuation of application No. 17/676,168, filed on Feb. 20, 2022, now Pat. No. 12,025,260.
Application No. 17/676,168 is a continuation of application No. 16/975,723, filed on Aug. 26, 2020, now Pat. No. 11,287,081.
(60) Provisional application No. 62/809,897, filed on Feb. 25, 2019.
(60) Provisional application No. 62/789,150, filed on Jan. 7, 2019.

(51) Int. Cl. F16M 11/12; F16M 11/04; F16M 11/06; F16M 11/18; F16M 11/20; G01B 7/00; G01D 5/14; G02B 7/18; G03B 17/56; G12B 5/00

(52) U.S. Cl. CPC F16M 11/125; F16M 11/18; G01D 5/145; G02B 7/1805; F16M 11/04; F16M 11/06; F16M 11/123; F16M 11/2035; G01B 7/00; G03B 17/561; G12B 5/00

(57) ABSTRACT

Rotation mechanisms for rotating a payload in two, first and second degrees of freedom (DOF), comprising a static base, a first rotation arm coupled mechanically to the static base through a first rotation joint and used for rotating the payload relative to the static base around a first rotation axis that passes through the first rotation joint, a second rotation arm coupled mechanically to the static base through a second rotation joint and used for rotating the payload relative to the static base around a second rotation axis that passes through the second rotation joint, and a follower member rigidly coupled to the payload and arranged to keep a constant distance from the second rotation arm, wherein the rotation of the first arm rotates the payload around the first DOF and the rotation of the second arm rotate the payload around the second DOF.

### CROSS REFERENCE TO RELATED APPLICATIONS

This application is a continuation from U.S. patent application Ser. No. 17/676,168 filed Feb. 20, 2022 (now allowed), which was a continuation from U.S. patent application Ser. No. 16/975,723 filed Aug. 26, 2020 (issued as U.S. Pat. No. 11,287,081), which was a 371 application from international patent application PCT/IB2019/061360 filed on Dec. 25, 2019, which claims priority from U.S. Provisional Patent Applications No. 62/789,150 filed on Jan. 7, 2019 and No. 62/809,897 filed on Feb. 25, 2019, both of which are expressly incorporated herein by reference in their entirety.

### FIELD

Embodiments disclosed herein relate in general to rotation mechanism and in particular to rotation mechanisms for various elements in small digital cameras included in electronic devices.

### BACKGROUND

Cameras for surveillance, automotive, etc. include mechanisms that enable advanced optical function such as optical image stabilization (OIS) and/or scanning the camera field of view (FOV). Such mechanisms may actuate (e.g. displace, shift or rotate) an optical element (e.g. lens, image sensor, prism, mirror or even an entire camera) to create the desired optical function.

Rotation mechanisms for rotating a payload (e.g. an optical element as above) in two degrees of freedom (DOF) are known. In known mechanisms in which one DOF is an internally rotating DOF and the other DOF is an external DOF, there is normally a problem in that the internally rotating DOF has its rotation axis rotated by the external DOF (Gimbal design). Known rotation mechanisms that solve the Gimbal problem use two fixed (not rotating) motors with more than three bearings or two rotating motors with two bearings.

### SUMMARY

Aspects of embodiments disclosed herein relate to rotation mechanisms for rotating a payload in two DOFs. We propose a method of having two rotation axes around two rotation points.

In various exemplary embodiments there are provided rotation mechanisms for rotating a payload in two, first and second DOFs, comprising a static base, a first rotation arm coupled mechanically to the static base through a first rotation joint and used for rotating the payload relative to the static base around a first rotation axis that passes through the first rotation joint, a second rotation arm coupled mechanically to the static base through a second rotation joint and used for rotating the payload relative to the static base around a second rotation axis that passes through the second rotation joint, and a follower member rigidly coupled to the payload and arranged to keep a constant distance from the second rotation arm, wherein the rotation of the first arm rotates the payload around the first DOF and the rotation of the second arm rotate the payload around the second DOF.

In some embodiments, the follower member is a magnetic member separated from the second rotation arm by a constant air-gap.

In some embodiments, the payload is coupled mechanically to the first rotation arm through an inner rotation joint.

In some embodiments, a rotation mechanism further comprises a first motor for rotating the payload relative to the static base around the first rotation axis and a second motor for rotating the payload relative to the static base around the second rotation axis, wherein the first and second motors are rigidly attached to the static base

In some embodiments, the second rotation arm is a ring section centered around the first rotation axis.

In some embodiments, the rotation mechanism further comprises at least one sensing mechanism for determining a position of the payload.

In some embodiments, a sensing mechanism comprises at least one pair of a magnet and a Hall sensor.

In some embodiments, a sensing mechanism is operable to determine a position of the payload relative to the static base in the first and second DOFs.

In some embodiments, a pair of a magnet and a Hall sensor comprises a first pair of a magnet and a Hall sensor that allows determination of a rotation of the payload around the first DOF, and a second pair of a magnet and a Hall sensor that allows determination of a rotation of the payload around the second DOF.

In some embodiments, determinations of the position of the payload relative to the static base in the two DOFs are decoupled from each other.

### BRIEF DESCRIPTION OF THE DRAWINGS

Aspects, embodiments and features disclosed herein will become apparent from the following detailed description when considered in conjunction with the accompanying drawings, in which:

FIG. 1A shows schematically in a perspective view an embodiment of a rotation mechanism for rotating a payload in two DOFs disclosed herein, at zero position;

FIG. 1B shows the mechanism of FIG. 1A coupled with exemplary first and second motors;

FIG. 1C shows in side view the mechanism of FIG. 1A at zero (non-rotated) position;

FIG. 1D shows in side view the mechanism of FIG. 1A at a rotated position around the first rotation axis;

FIG. 1E shows the rotation of a second rotation arm in the mechanism of FIG. 1A around a second rotation axis;

FIG. 2A shows schematically in a perspective view another embodiment of a rotation mechanism for rotating a payload in two DOFs disclosed herein, at zero position.

FIG. 2B shows in side view the mechanism of FIG. 2A at a rotated position, around both rotation axes;

FIG. 3A shows schematically in a perspective view yet another embodiment of a rotation mechanism for rotating a payload in two DOFs disclosed herein, at zero position.

FIG. 3B shows the mechanism of FIG. 2A in a top view;

FIG. 3C shows one perspective view of an exemplary case in which the first rotation arm is rotated around the first DOF;

FIG. 3D shows another perspective view of the exemplary case of FIG. 3C.

### DETAILED DESCRIPTION

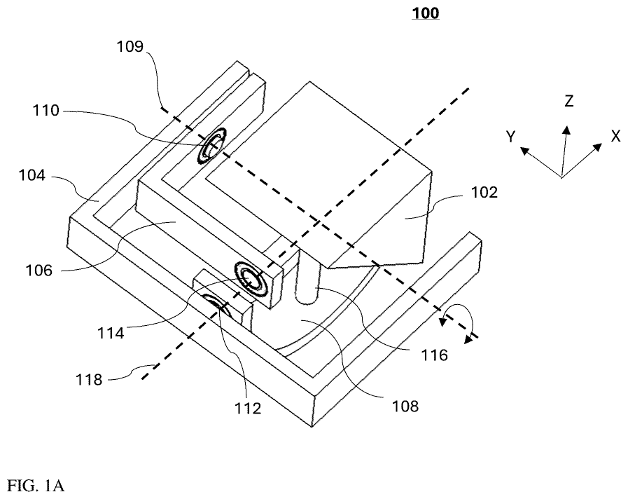

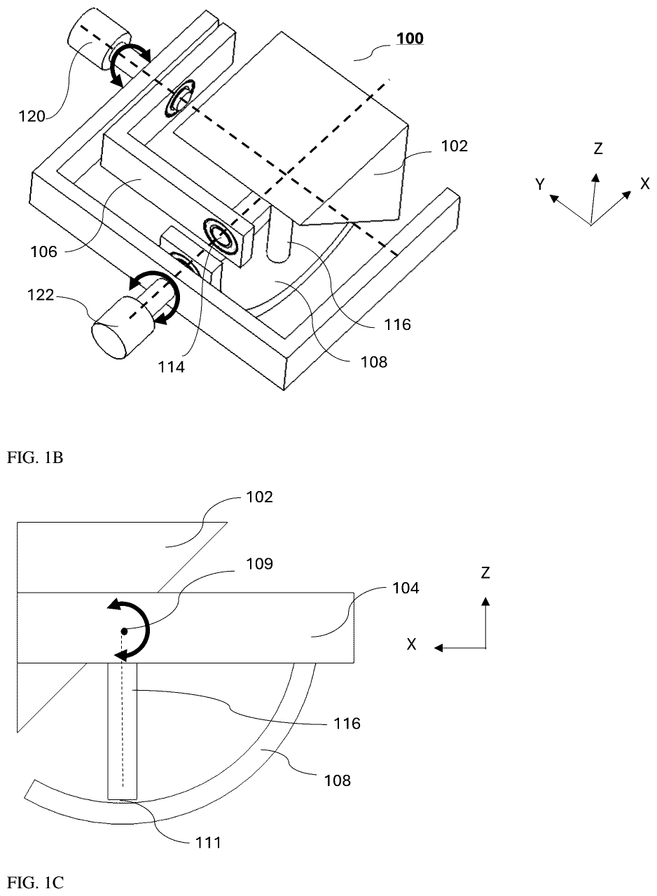

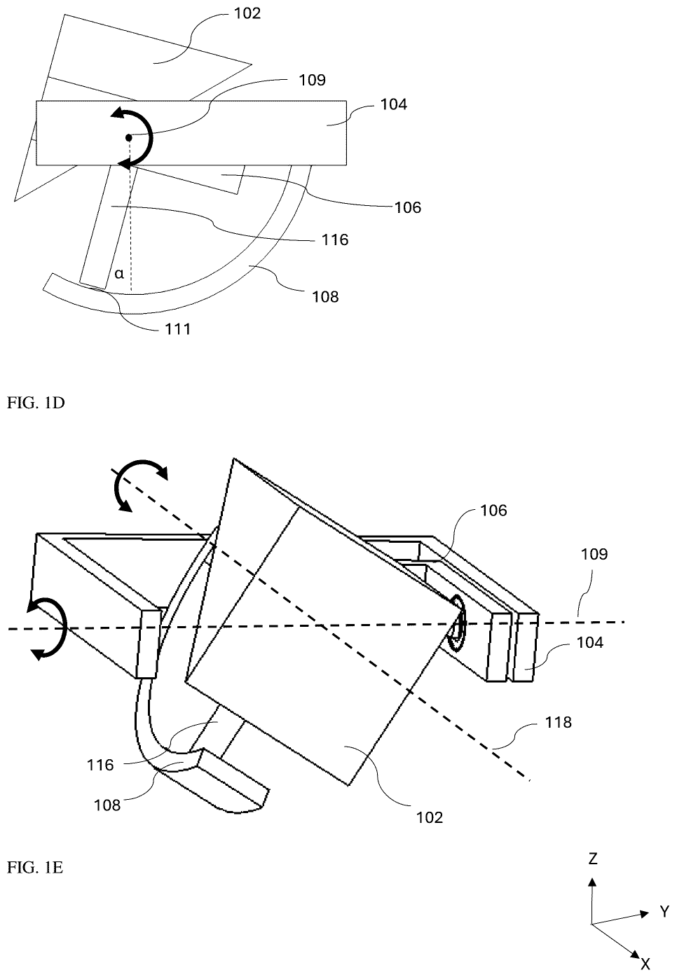

FIG. 1A shows schematically in a perspective view an embodiment of a rotation mechanism (or simply “mechanism”) disclosed herein and numbered 100. Mechanism 100 is used for rotating a payload 102 in two DOFs disclosed herein, at zero position (initial position, without any actuation, not rotated). An exemplary XYZ coordinate system shown applies also to all following perspective views. Payload 102 is shown as a prism, but may be any element, and in particular any optical element, such as (and not limited to) a lens, an image sensor, a prism, a mirror or an entire camera. Mechanism 100 includes a static base 104 (i.e. a fixed base that does not move), a first rotation arm 106, a second rotation arm 108 and a magnetic follower 116. First rotation arm 106 can rotate relative to static base 104 around a first rotation axis 109 (shown exemplarily in the Y direction). First rotation axis 109 passes through a first rotation joint 110 that couples first rotation arm 106 mechanically with static base 104 (e.g. using a ball bearing). Second rotation arm 108 has a shape of a circle section with a center on a first rotation axis 109. A second rotation axis 118 passes through a second rotation point 112 that mechanically connects second rotation arm 108 with static base 104 (e.g. using a ring ball bearing). Second rotation arm 108 can rotate relative to static base 104 around second rotation axis 118 (shown exemplarily in the X direction). The first and second rotation axes may be perpendicular to each other. Magnetic follower 116 may made of a permanent (fixed) magnet (or at least the tip facing second rotation arm is made of a permanent magnet). Second rotation arm 108 may be made of a ferromagnetic material. Alternatively, the second rotation arm may be made of a rigid material such as a plastic material or a non-ferromagnetic metal covered with a ferromagnetic material on a side facing magnetic follower 116. Magnetic follower 116 is distanced from second rotation arm 108 by an air-gap 111 (FIG. 1C), and allows payload 102 to follow second rotation arm 108 without having magnetic follower 116 touch second rotation arm 108 directly.

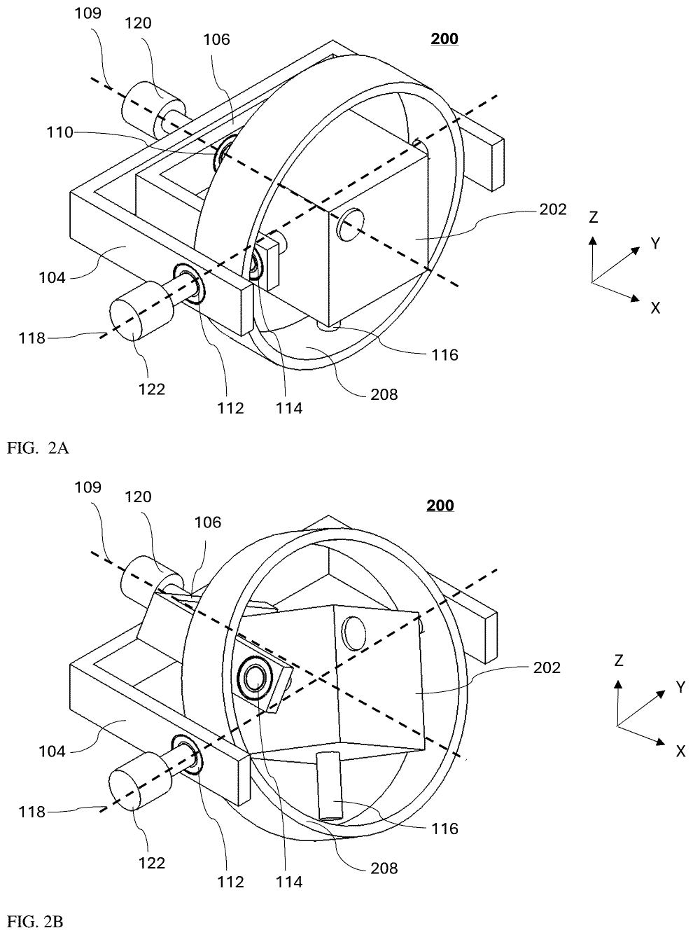

First rotation arm 106 and second rotation arm 108 can be rotated relative to rotation joints 110 and 112 respectively (each arm around one rotation point). The rotation can be performed by any motor (e.g. stepper, DC, brushless, VCM, etc.). An inner rotation point 114 connects payload 102 to first rotation arm 106 (e.g. using ring ball bearing) and allows payload 102 to rotate in a second DOF (see FIG. 1E). First rotation arm 106, first rotation joint 110 and inner rotation point 114 are similar to elements of a gimbal. Note that inner rotation point 114 is on second rotation axis 118 at zero point (as seen in FIG. 1A) but when first rotation arm 106 is rotated inner rotation point 114 rotates with it and is shifted from second rotation axis 118, as seen for example in FIG. 2B.

FIG. 1B shows mechanism 100 coupled with exemplary first and second motors 120 and 122, which drive a rotation movement around the first and second rotation axes respectively.

Advantageously, motors 120 and 122 are stationary relative to static base 104. In other embodiments, motors 120 and 124 may have different shapes and sizes, may be equal to one another or different in size, technology of actuation, etc.

FIG. 1C shows mechanism 100 in a zero, non-rotated position (same as in FIG. 1A), while FIG. 1D shows mechanism 100 in a second, rotated position. Both FIGS. 1C and 1D are given in a side view in an exemplary X-Z plane (looking from positive to negative Y direction). In FIG. 1D, first rotation arm 106 is rotated around first rotation axis 109 (e.g. using first motor 120) relative to the base 104 and payload 102 rotates with it. Magnetic follower 116 stays distanced from second rotation arm 108 by a constant distance (air-gap 111). The rotation around first rotation point may be in any angle α. The angle limitation shown in FIGS. 1A-E is due only to the length of second rotation arm 108, which as shown is about a quarter of a circle in length. In other embodiments, the second rotation arm may be a complete circle, such that rotation of the first rotation arm around the first rotation axis may be up to 360 degrees.

FIG. 1E shows the rotation of second rotation arm 108 (e.g. using second motor 122) around the second rotation axis. Magnetic follower 116 is pulled to second rotation arm 108 by the magnetic force and thus rotates with it and rotates payload 102 relative to first rotation arm 106 around inner rotation point 114 in the second DOF. The rotation of the magnetic follower is independent of the rotation of first rotation arm 106 around first rotation axis 109 in the first DOF, because magnetic follower 116 is pulled to the second rotation arm 108 equally in all positions along first DOF. Magnetic follower 116 following second rotation arm 108 forms a “sliding joint”, e.g. a joint that allows magnetic follower 116 to follow second rotation arm 108 in one (first) DOF while sliding without interference in a second DOF.

FIGS. 2A and 2B show in perspective views another embodiment of a rotation mechanism disclosed herein and numbered 200. Mechanism 200 is similar to mechanism 100, with identical parts in both mechanisms numbered with identical numerals. In mechanism 200, the payload is a exemplarily a camera 202, and a second rotation arm 208 is a full circle, which enables rotation around the first rotation axis by 360 degrees. In FIG. 1A, mechanism 200 is shown in a rest (non-rotated) position, while in FIG. 1B, mechanism 200 is shown in position rotated by 30 degrees from the rest position.

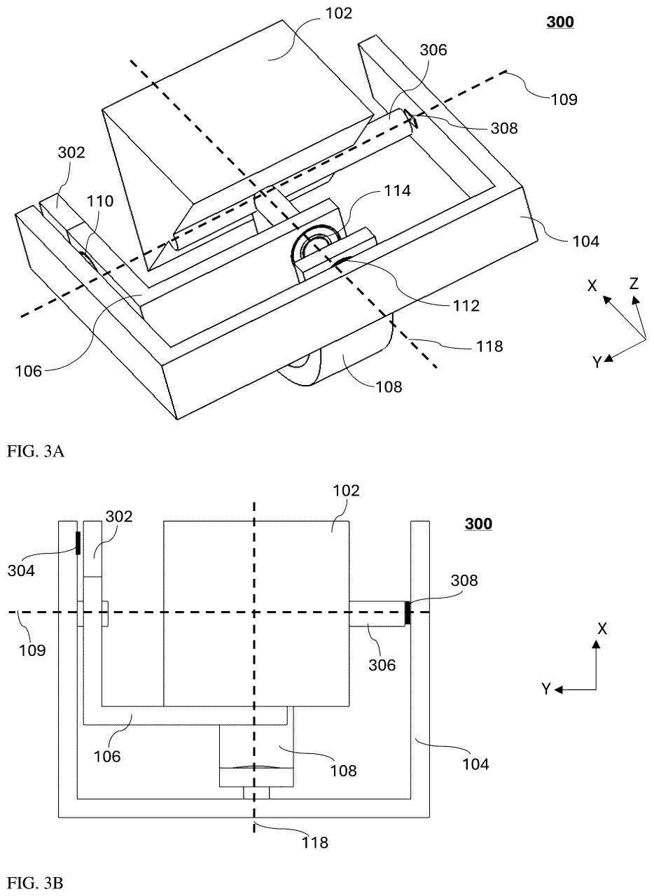

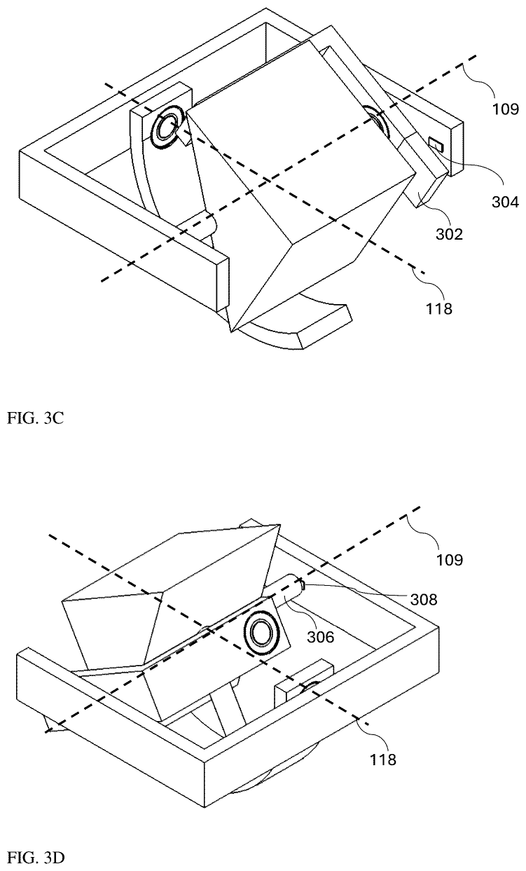

FIGS. 3A-D show yet another embodiment of a rotation mechanism disclosed herein and numbered 300. Rotation mechanism 300 is similar to mechanism 100, with identical parts in both mechanisms numbered with identical numerals. Relative to mechanism 100, mechanism 300 is equipped with two position sensing mechanisms, enabling determining a relative position (orientation/rotation) of payload 102 relative to frame 104 in two DOF. The position sensing mechanisms comprise at least one pair of a magnet and a Hall sensor. In some embodiments, a position sensing mechanism may comprise more than one magnet and/or more than one Hall sensor. FIG. 3A shows a perspective view of mechanism 300, and FIG. 3B shows a top view. Mechanism 300 comprises a first magnet 302 rigidly coupled to first rotation arm 106 and a first Hall sensor 304 rigidly coupled to base 104. Mechanism 300 further comprises a second magnet 306 rigidly coupled to payload 102, and a second Hall sensor 308 rigidly coupled to base 104. In an example, the position of the second Hall sensor is on first rotation axis 109. In an example, Hall sensors 304 and 308 can measure the intensity of the magnetic field in the Y direction. In particular, first Hall sensor 304 is positioned close to first magnet 302 and can measure the intensity of the magnetic field of first magnet 302, which can be correlated with the rotation of the payload around the first DOF. Second Hall sensor 308 is positioned close to second magnet 306 and can measure the intensity of the magnetic field of second magnet 306, which can be correlated with the rotation of the payload around the second DOF. FIGS. 3C and 3D show, from two different perspective views, an exemplary case where the first rotation arm 106 is rotated around the first DOF (e.g. in 30 degrees). The relative position of first magnet 302 and first Hall bar 304 is changed, while the relative position of second magnet 306 and second Hall bar 308 is unchanged. Similarly, when rotating payload 102 around the second DOF using second rotation arm 108, the relative position of first magnet 302 and first Hall bar 304 is unchanged, while the relative position of second magnet 306 and second Hall bar 308 is changed. Thus the measurements of the two DOFs are decoupled from each other.

In summary, disclosed above are rotation mechanisms having a design with at least the following advantages:
Ability to rotate around two degrees of freedom.
The motors are stationary.
Only three mechanical connection points (bearings) are used to create the rotation, compared with at least four bearings in other designs in which the motors are stationary, for example in “Dynamic modeling and base inertial parameters determination of a 2-DOF spherical parallel mechanism” Danaci, B. et al., Multibody Syst. Dyn. (2017) 41: 367, doi:10.1007/s11044-017-9578-3, and “Optimal Design of Spherical 5R Parallel Manipulators Considering the Motion/Force Transmissibility”, Chao Wu et al., J. Mech. Des. (2010) 132(3), doi:10.1115/1.4001129.

While this disclosure describes a limited number of embodiments, it will be appreciated that many variations, modifications and other applications of such embodiments may be made. For example, the magnetic follower can be replaced with a mechanical follower.

In general, the disclosure is to be understood as not limited by the specific embodiments described herein, but only by the scope of the appended claims.

All references mentioned in this specification are herein incorporated in their entirety by reference into the specification, to the same extent as if each individual reference was specifically and individually indicated to be incorporated herein by reference. In addition, citation or identification of any reference in this application shall not be construed as an admission that such reference is available as prior art to the present application.

What is claimed is:

1. A camera, comprising: a rotation mechanism for rotating a payload in two, first and second degrees of freedom (DOF), the rotation mechanism comprising a static base, a first rotation arm coupled mechanically to the static base through a first rotation joint and used for rotating the payload relative to the static base around a first rotation axis that passes through the first rotation joint, and a second rotation arm coupled mechanically to the static base through a second rotation joint and used for rotating the payload relative to the static base around a second rotation axis that passes through the second rotation joint,
wherein the rotation of the first arm rotates the payload around the first DOF, and wherein the rotation of the second arm rotates the payload around the second DOF.

2. The camera of claim 1, wherein the rotation mechanism further comprises a follower member rigidly coupled to the payload and arranged to keep a constant distance from the second rotation arm.

3. The camera of claim 1, wherein the payload is coupled mechanically to the first rotation arm through an inner rotation joint.

4. The camera of claim 1, wherein the rotation mechanism further comprises a first motor for rotating the payload relative to the static base around the first rotation axis and a second motor for rotating the payload relative to the static base around the second rotation axis, wherein the first and second motors are rigidly attached to the static base.

5. The camera of claim 1, wherein the follower member is a magnetic member separated from the second rotation arm by a constant air-gap.

6. The camera of claim 2, wherein the rotation mechanism further comprises a first motor for rotating the payload relative to the static base around the first rotation axis and a second motor for rotating the payload relative to the static base around the second rotation axis, wherein the first and second motors are rigidly attached to the static base.

7. The camera of claim 2, wherein the follower member is a magnetic member separated from the second rotation arm by a constant air-gap.

8. The camera of claim 3, wherein the follower member is a magnetic member separated from the second rotation arm by a constant air-gap.

9. The camera of claim 1, wherein the second rotation arm includes a ring section centered around the first rotation axis.

10. The camera of claim 1, wherein the rotation mechanism includes one or more Hall sensors.

11. The camera of claim 1, wherein the rotation of the first rotation arm around the first rotation axis is up to 360 degrees.

12. The camera of claim 1, wherein the rotation mechanism is operational to enable optical image stabilization.

13. The camera of claim 1, wherein the rotation mechanism is operational to scan a camera field of view.

14. The camera of claim 1, wherein the rotation mechanism is operational to actuate an optical element.

15. The camera of claim 14, wherein the optical element is a lens.

16. The camera of claim 14, wherein the optical element is an image sensor.

17. The camera of claim 14, wherein the optical element is a prism.

18. The camera of claim 14, wherein the optical element is a mirror.

19. The camera of claim 1, wherein the camera is a small digital camera included in an electronic device.
